(19) United States
(12) Patent Application Publication
(10) Pub. No.: US 2009/0177538 A1
(43) Pub. Date: Jul. 9, 2009

(54) ZOOMABLE ADVERTISEMENTS WITH TARGETED CONTENT

(75) Inventors: Brett Brewer, Sammamish, WA (US); Ron Karidi, Herzeliya (IL)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/970,530

(22) Filed: Jan. 8, 2008

(51) Int. Cl. G06Q 30/00; G06F 17/00

(52) U.S. Cl. 705/14; 715/273

(57) ABSTRACT

Advertisements may be displayed on electronic devices within a variety of contexts, such as websites and applications, but the amount of information that may be conveyed by small advertisements in a portion of the screen may be limited. One technique for displaying information in a limited space involves a zoomable advertisement, wherein the advertisement displayed in a first zoom state is supplemented with additional information upon transitioning to a second zoom state (e.g., zooming in to visualize small content, and zooming out to visualize content that was out of bounds in the first zoom state.) Moreover, the content visible at the second zoom state may present advertising content targeted with respect to the user and based on one or more user criteria. The system may notify an advertisement tracking server of various events, e.g., upon rendering the targeted content on behalf of the user.

### BACKGROUND

Advertisements presented on electronic components may take many forms, such as image banners and interactive web applications, and may be embedded in many host applications, such as a website offered by a web browser, an image hosted by an image server, and a document managed by a document authoring application. Such advertisements may display advertisements for a variety of contexts, such as a banner advertisement hosted in a webpage or an image located in a text document. The content of the advertisement may also be targeted with respect to the user, e.g., by including information in the advertisement that relates to some details that have been detected about the user, such as the user's geographic location.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

An advertisement located in an advertisement host, such as a webpage or an application, may seek to convey information about the advertised good, service, company, or organization. However, such advertisements may be limited to a fixed area, such as within a fixed-dimension region of a webpage or application window, and a static advertisement of the provided dimensions may have an inadequate amount of advertising space for displaying all of the information that could advantageously be included in the advertisement.

An alternative technique for displaying additional information relates to the manner of using the fixed-dimension space allocated for the advertisement. The alternative technique involves an advertisement that may be displayed in various zoom states, e.g., where the content of the advertisement may be viewed at different zoom levels and positions. The advertisement may be therefore be designed to display some content at a first zoom state, and to display additional content at a second state, e.g., by zooming in on a portion of the content viewable in the first zoom state upon detecting a user interaction with the advertisement. Moreover, the information displayed at the second zoom state may be targeted with respect to the user, such as by presenting information (such as text, images, video, etc.) particular to the user's location, interests, or demographics, in order to provide a more attention-grabbing or persuasive advertisement. An advertisement having information arranged at different zoom states, with targeted advertisement content provided at a second zoom state, may more advantageously use a fixed-dimension advertising space than static advertisements and other techniques.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary user criteria set describing a user set.

FIG. 2 is an illustration of three targeted advertisements corresponding to the three exemplary user criteria sets representing three users of FIG. 1.

FIG. 3 is a flow diagram of an exemplary method of rendering an advertisement having at least two zoom states and targeting a user represented by at least one user criterion.

FIG. 4 is a component block diagram of an exemplary system for rendering an advertisement having at least two zoom states and targeting a user represented by at least one user criterion.

FIG. 5 is an illustration of an exemplary computer-readable medium comprising processor-executable instructions configured to embody the techniques disclosed herein.

FIG. 6 is an illustration of another exemplary advertisement having a continuously zoomable aspect.

FIG. 7 is a component block diagram of another exemplary system for rendering an advertisement having at least two zoom states and targeting a user represented by at least one user criterion.

FIG. 8 is a component block diagram of an exemplary advertisement rendering system and advertising server cooperatively configured to render an advertisement having at least two zoom states and targeting a user represented by at least one user criterion.

FIG. 9 is a component block diagram of another exemplary advertisement rendering system and advertising server cooperatively configured to render an advertisement having at least two zoom states and targeting a user represented by at least one user criterion.

FIG. 10 is a component block diagram of yet another exemplary advertisement rendering system and advertising server cooperatively configured to render an advertisement having at least two zoom states and targeting a user represented by at least one user criterion.

FIG. 11 is a component block diagram of yet another exemplary advertisement rendering system and advertising server cooperatively configured to render an advertisement having at least two zoom states and targeting a user represented by at least one user criterion.

FIG. 12 is an illustration of another exemplary advertisement having a continuously zoomable aspect.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Contemporary computer systems have been configured in many ways to display advertisements to users for various goods, services, companies, and organizations. Advertisements may be embedded in webpages, in computer-displayable media documents such as texts and movies, in applications and games, etc. (Such user interfaces in which an advertisement may be positioned are referred to herein as “advertisement hosts.”) Many forms of simpler advertisements comprise a static, fixed-resolution, and predominantly non-interactive set of text and/or graphics, such as a banner advertisement in a website or a watermark (e.g., the URL of a website) included in an image.

Such static and fixed-resolution advertisements may be expressly positioned and sized within a designated region of an advertisement host, such as within a banner region of a webpage or a specified header portion of a text document. The dimensions may be carefully specified to fit within a well-defined region, and conformance with the specified dimensions may be desirable, such as where the positioning of the advertisement may affect the positions and sizes of other elements within the advertisement host (e.g., other advertisements, the media content of the advertisement host, user interface controls, etc.) The dimensions may also be heavily constrained where the advertisement is rendered on a device having a small-resolution display, such as a cellphone, personal data assistant (PDA), ultramobile personal computer (UMPC), portable gaming machine, or similar device. In such scenarios, rendering the advertisement within a well-defined and potentially small area may be a significant consideration.

However, the amount of space provided for a fixed-resolution advertisement may impose a significant constraint on the amount of information that the advertisement may display. As one example, it may be difficult to display within the fixed-resolution advertising space all of the text that a designer of a text advertisement may wish to include in relation to the advertised good, service, company, or organization. The text may be displayed with a smaller font, but this may reduce the readability of the text. Alternatively, the text may be displayed non-statically with horizontal or vertical scrolling, but this may also be difficult to read, and may also introduce a visual distraction in the advertisement host that detracts from the visual aesthetic and/or visual utility of the user interface.

As another alternative, the advertisement may be devised to escape the confines of the defined advertisement space in certain circumstances. As one example, when the user hovers a pointer over the area of the advertisement, the advertisement may temporarily grow to fill a larger portion of the application host in order to present more information, and may shrink to the original dimensions of the advertisement when the user moves the pointer away from the advertisement. However, this technique may undesirably obscure some content within the advertisement host, and may represent a visual distraction for a user who unintentionally hovers the pointer over the advertisement. As another example, upon detecting a user click upon the advertisement, the advertisement may generate a supplemental advertisement outside of the advertisement host, such as a pop-over or pop-under window in a webpage. However, these supplemental advertisements may undesirably divert the user's attention from the context of the advertisement host. For example, pop-over advertisements may diver the user's attention in a particularly abrupt manner that diminishes the persuasiveness of the advertisement, while pop-under advertisements may not be noticed by the user until the user closes a browser window (and perhaps others), which may occur at a considerably later period when the advertisement is no longer relevant (e.g., after the user has already located and purchased a product such as advertised in the pop-under advertisement.) In both cases, the pop-up advertisements may remove the user from the viewing context of the advertisement host, which may be undesirable where the user does not or cannot return focus on the advertisement host at a later date or time. Moreover, the user may be less willing to interact with the advertisements in anticipation of the context switch caused thereby.

The techniques presented herein relate to the use of advertising space to convey advertising information in a manner that may be more advantageous than these alternatives. The techniques relate to a zoomable advertisement, in which a portion of the advertisement may be zoomed in to reveal more detail, and/or the viewed portion of the advertisement may be zoomed out to reveal additional portions of the advertisement at the peripheries of the viewed portion. Moreover, the advertising content at the new zoom state may contain targeted advertising information that may be of added significance to the user, and may result in a more attention-catching or persuasive advertisement.

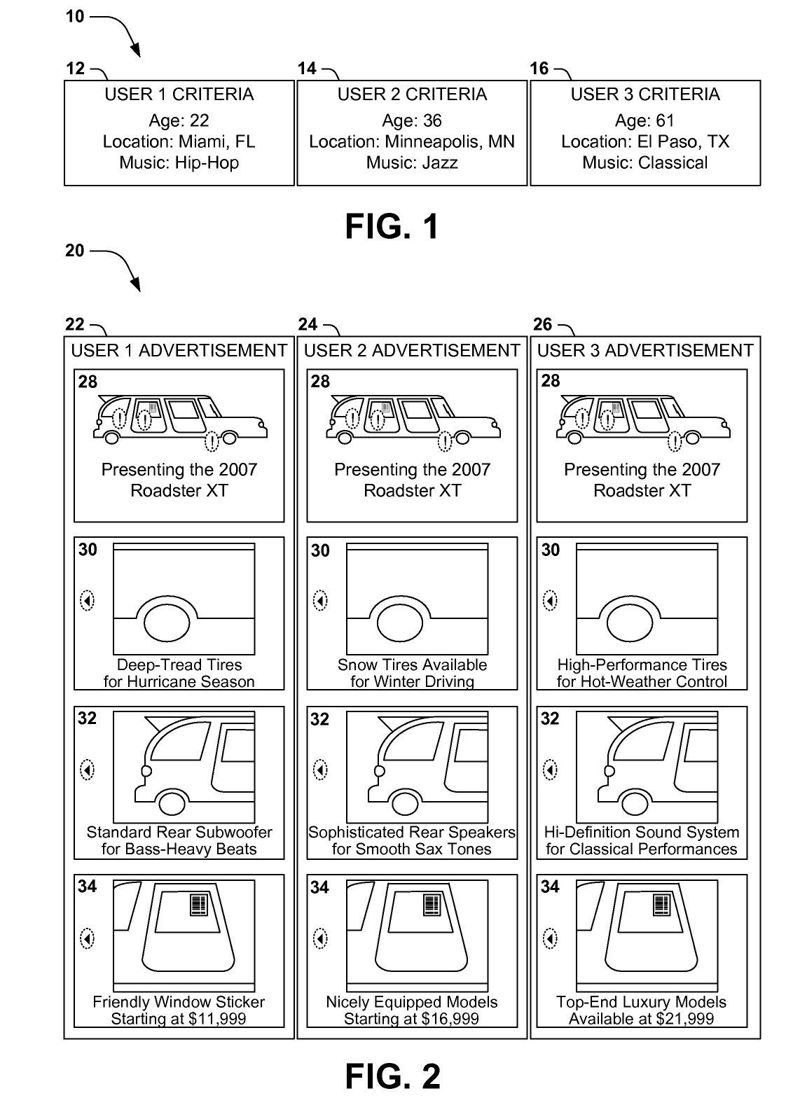

FIGS. 1-2 illustrate an exemplary application of these techniques to display an advertisement for a new model of a car. The advertisements are targeted to various users, about which user criteria may be detected and collected for use in building into the advertisement some targeted content that describes various features of the new car model in a manner that may appeal to each individual. The advertisements are presumably displayed in a small rectangular area, such as may be positioned (e.g.) in a corner of a website or a computer application to include advertising content without overwhelming the main content of the website or computer application.

FIG. 1 illustrates an exemplary user criteria set 10, where each record contains some user criteria describing a user to facilitate the selection of targeted advertising content. The exemplary user criteria set 10 includes a first user criteria set 12 collected to describe a first user, who is a young individual from Miami, Fla. and who has demonstrated a musical preference for hip-hop. The exemplary user criteria set 10 also includes a second user criteria set 14 collected to describe a second user, who is a middle-aged individual from Minneapolis, Minn. and who has demonstrated a musical preference for jazz. The exemplary user criteria set 10 also includes a third user criteria set 16 collected to describe a third user, who is an older individual from El Paso, Tex. and who has demonstrated an interest in classical music. This information may have been collected through a variety of sources; e.g., each user may have provided the information through the website of the automobile manufacturer, or may have provided the information to other sources (e.g., other internet retailers) that may be collected and analyzed to produce a user profile of each user.

FIG. 2 illustrates an exemplary advertisement 20 in accordance with the techniques described herein that is targeted to the three individuals represented in the exemplary user criteria set 10 of FIG. 1, specifically, a first user advertisement 22 generated in relation to the first user criteria set 12, a second user advertisement 24 generated in relation to the second user criteria set 14, and a third user advertisement 26 generated in relation to the third user criteria set 16. Each of the advertisements begins with an advertisement overview panel 28 that displays and introduces the car. The advertisement overview panel 28 is presented in a first zoom state (in this exemplary advertisement 20, such that the entire car is visible, and with some introductory text that introduces the model.

The advertisement overview panel 28 also includes some areas that the user may select to zoom in on various portions of the vehicle for more detail, which also presents some information targeted to the user. For example, a user may zoom in on the front tire of the car in the advertisement overview panel 28 to display (in the same advertising area) a zoomed-in view of the front tire, i.e., a second zoom state 30 of the vehicle. The second zoom state 30 may show the front tire in more detail than the corresponding view of the front tire in the advertisement overview panel 28; for example, the second zoom state 30 may depict tire tread and wheel characteristics that were not visible in the distance view of the same portion of the vehicle in the advertisement overview panel 28. In this exemplary advertisement 20, the second zoom state 30 also includes some text to present the tire to a particular user as having features that target the criteria of the user. For example, the first user criteria set 12 indicates that the first user is located in Miami, Fla., so the advertisement includes in the second zoom state 30 an indication of the availability of deep-tread tires for additional safety during hurricane season in Miami. By contrast, the second user criteria set 14 indicates that the second user is located in Minneapolis, Minn., so the advertisement includes in the second zoom state 30 an indication of the availability of snow tires. The third user criteria set 16 indicates that the third user is located in El Paso, Tex., so the advertisement is customized to present in the second zoom state 30 an indication of the availability of high-performance tires that perform well in hot conditions, such as desert conditions. The second zoom state 30 may also include an indicator (in this example, a small “back” icon) that may be clicked to return to the advertisement overview panel 28.

The advertisement overview panel 28 also includes an indication that clicking on the rear window of the vehicle may present a third zoom state 32, which is focused on the rear portion of the vehicle where the components of a sound system may be located. In this third zoom state 32, the sound system is described in a manner that may appeal to each user, based on the musical preferences stored in the exemplary user criteria set 10 of FIG. 1. For example, the first user criteria set 12 indicates that the first user has a musical preference for hip-hop, so the third zoom state 32 may emphasize the strong bass response of the sound system of the car. By contrast, the second user criteria set 14 indicates that the second user prefers jazz, so the third zoom state 32 may indicate the high-fidelity saxophone tone capabilities of the sound system; and the third user criteria set 16 indicates that the third user prefers classical music, so the third zoom state 32 may suggest for the third user a high-performance sound system that can accurately produce a high-precision broad frequency response as may be appropriate for orchestral performances. The advertisement overview panel 28 may also include a window-sticker zooming indicator that leads to a fourth zoom state 34 that is zoomed in on the window sticker of the vehicle. The fourth zoom state 34 may also be customized based on the predicted income of the users, based on each user's demographic information stored in the exemplary user criteria set 10. For example, the first user may be presumed to occupy a comparatively low-level income bracket, so the fourth zoom state 34 may display a base price for the vehicle; the second user may be presumed to occupy a comparatively mid-level income bracket, so the fourth zoom state 34 may display a mid-range and mid-priced equipping of the vehicle; and the third user may be presumed to occupy a comparatively high-level income bracket, so the fourth zoom state 34 may display a high-price but luxury-equipped model of the vehicle. In this manner, the exemplary advertisement 20 demonstrates the inclusion of targeted content at a second zoom state in a zoomable advertisement, in accordance with the techniques provided herein.

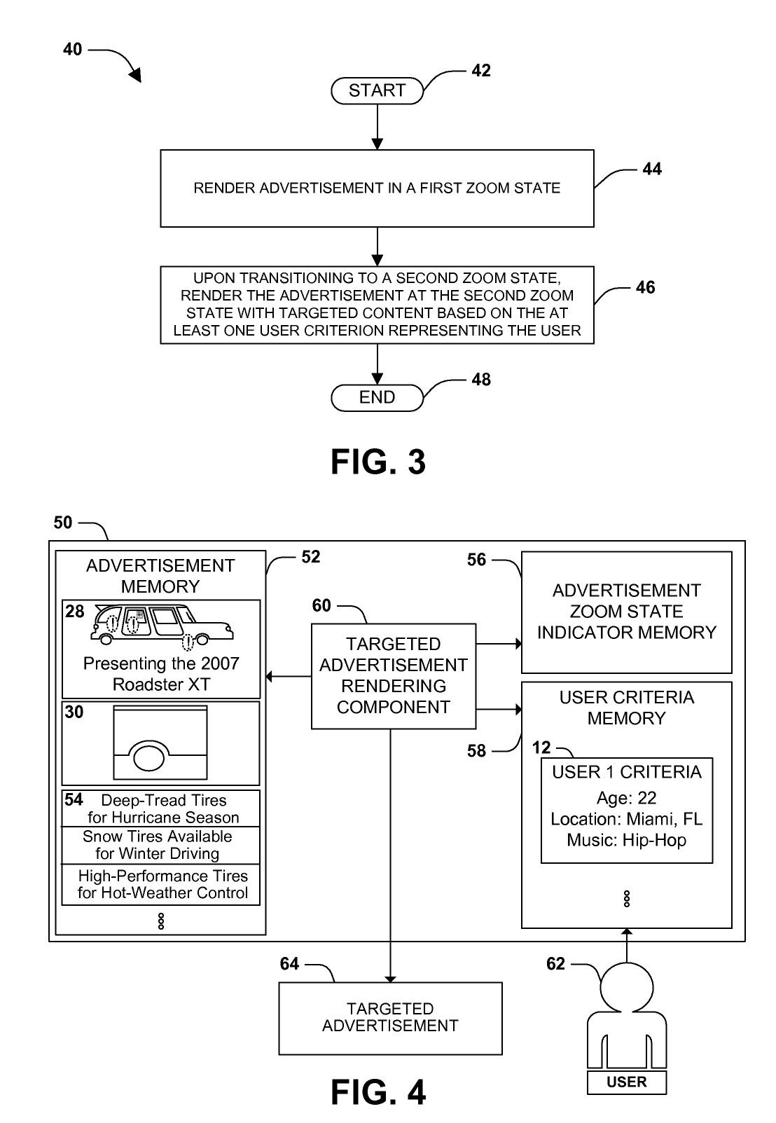

The techniques described herein and illustrated in the example of FIGS. 1-2 may be embodied in many forms. FIG. 3 presents one embodiment as an exemplary method 40 of rendering an advertisement having at least two zoom states and targeting a user represented by at least one user criterion. The exemplary method 40 begins at 42 and involves rendering the advertisement in a first zoom state 44. The first zoom state may comprise, e.g., a zoomed-out point in the advertisement, such as the advertisement overview panel 28 of FIG. 2. The exemplary method 40 also involves, upon transitioning to a second zoom state, rendering the advertisement at the second zoom state with targeted content based on the at least one user criterion representing the user 46. Having presented a zoomable advertisement featuring user-targeted content on the second zoom state, the exemplary method 40 accomplishes the rendering of the advertisement with user-targeted content, and so ends at 48.

FIG. 4 illustrates another embodiment of the techniques presented herein, in the form of an exemplary system 50 for rendering an advertisement having at least two zoom states and targeting a user 62 represented by at least one user criterion 12. The exemplary system 50 includes an advertisement memory 52 configured to store the advertisement (e.g., the panels comprising the exemplary advertisement 20 of FIG. 2, such as the advertisement overview panel 28, the second zoom state 30, etc.), as well as the targeted content (e.g., a second zoom state descriptor set 54 containing various descriptors that may be included with the second zoom state 30, from which a descriptor may be chosen to target the user 62 based on the at least one user criterion 12.) The exemplary system 50 also includes an advertisement zoom state indicator memory 56 that stores an advertisement zoom state indicator in order to track the current zoom state of the advertisement. The exemplary system 50 also includes a user criteria memory 58 that stores at least one user criterion 12 representing the user 62. The exemplary system 50 also includes a targeted advertisement rendering component 60, which is configured to produce a targeted advertisement 64 having targeted content related to the user 62. The targeted advertisement rendering component 60 accomplishes the rendering of the targeted advertisement 64 by rendering the advertisement stored in the advertisement memory 52 at the advertisement zoom state indicated by the advertisement zoom state indicator memory 56; and upon transitioning to a second zoom state, rendering within the second zoom state the targeted content stored in the advertisement memory 52 and targeting the at least one user criterion 12 stored in the user criteria memory 58. It may be appreciated that the transitioning to the second zoom state may occur automatically, e.g., after a time delay, or manually, e.g., after detecting a user action (such as a mouse-over or mouse-click event indicating a user interaction with the advertisement) operably coupled with a zoom state transition. The exemplary system 50 configured in this manner therefore accomplishes the rendering of the targeted advertisement 64 having targeted content 54 at a second zoom state relating to the at least one user criterion 12 representing the user 62.

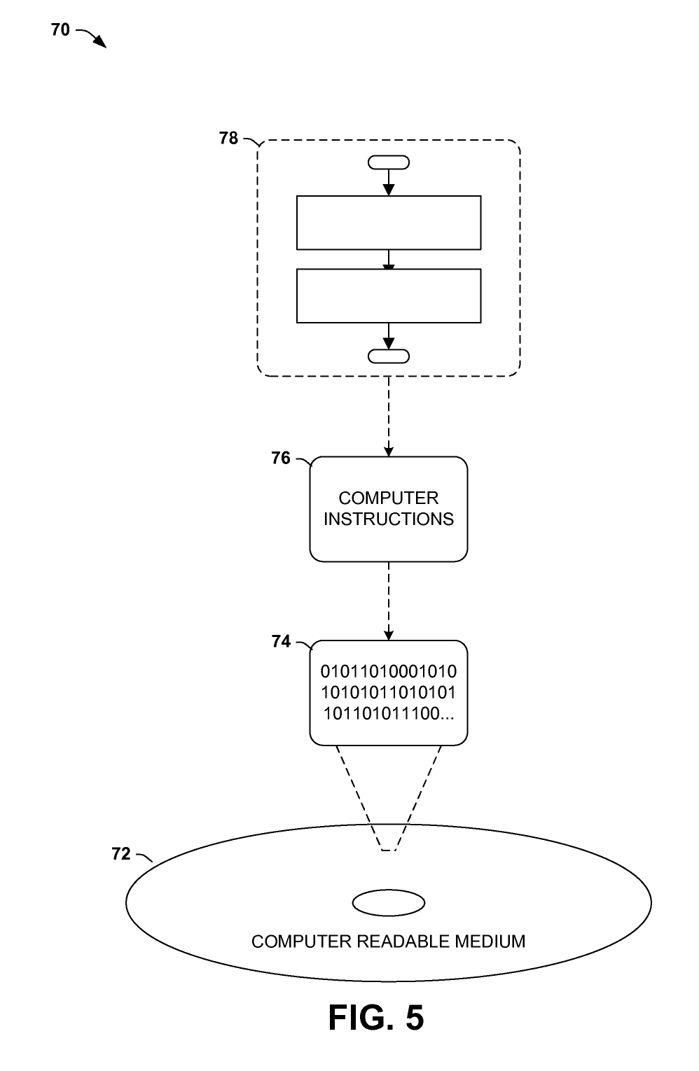

FIG. 5 illustrates still another embodiment involving a computer-readable medium 70 comprising processor-executable instructions configured to apply the techniques presented herein. This exemplary computer-readable medium 70 comprises a computer-readable medium 72 (e.g., a CD-R, DVD-R, or a platter of a hard disk drive), on which is encoded computer-readable data 74. This computer-readable data 74 in turn comprises a set of computer instructions 76 configured to operate according to the principles set forth herein. In one such embodiment, such as illustrated in FIG. 5, the processor-executable instructions 76 may be configured to perform a method of rendering an advertisement having at least two zoom states and targeting a user represented by at least one user criterion, such as the exemplary method 40 of FIG. 3. In another such embodiment, the processor-executable instructions 76 may be configured to implement a system for rendering an advertisement having at least two zoom states and targeting a user represented by at least one user criterion, such as the exemplary system 50 of FIG. 4. Many such computer-readable media may be devised by those of ordinary skill in the art that are configured to operate in accordance with the techniques presented herein.

The techniques presented herein, including the exemplary method 40 of FIG. 3, the exemplary system 50 of FIG. 4, and the exemplary computer-readable medium 70 of FIG. 5, may be embodied with variations in many aspects, wherein such variations may present additional advantages and/or reduce disadvantages with respect to other variations of these and other techniques. A first aspect that may be variously implemented relates to the form of the advertisement, which may comprise, e.g., a website having one or more webpages; a document, such as a text or multimedia document, having one or more document pages; a media item, such as one or more images or movies; and an application comprising one or more display states, such as dialog windows, menus, full-screen display states, etc. In accordance with the techniques presented herein, the various embodiments of the advertisement may be rendered at two or more zoom states, wherein the advertisement may be displayed at a second zoom state with targeted content based on the user criteria representing the user. For example, the advertisement may comprise a webpage that is initially illustrated in a zoomed-out condition representing a first zoom state; and upon zooming in on a portion of the webpage to a second zoom state, the advertisement may include some targeted content that may not have been visible in the zoomed-out condition of the first zoom state. As another example, such as shown in the examples of FIGS. 1-2, the advertisement may be presented as an image illustrated in whole in a first zoom state; and upon zooming in on a portion of the image to a second zoom state, the advertisement may include targeted information that may not have been visible at the first zoom state. As a third example, the advertisement may be embodied as a movie, which may permit the user to transition the movie to a second zoom state having targeted content. Similarly, the targeted content may comprise many forms of information, such as text, images, videos, interactive applications related to the user, etc., and combinations thereof. The targeted content may even comprise (e.g.) a sound containing information pertinent to the user, which is played for the user upon transitioning to the second zoom state. Many variations in the presented form of the advertisement may be devised by those of ordinary skill in the art while implementing the techniques discussed herein.

A second aspect that may be variously implemented relates to the embedding of the advertisement within an advertisement host. Just as the advertisement may be implemented in many forms, such as a website or an image, the advertisement may also be hosted in advertisement hosts of many forms, such as websites and images. Moreover, the advertisement may be limited to a defined region within the advertisement host, such as a specific position and size of the advertisement within a hosting webpage, or within a particular tab of a dialog comprising an application hosting the advertisement. As one example, the advertisement may comprise a website embedded in a document serving as the advertisement host; i.e., the document may contain a defined region comprising a portal to a website having one or more pages, and where at least one webpage may be displayed in a second zoom state (e.g., zoomed in on a particular portion of the webpage) having targeted content. As a second example, an advertisement may comprise a zoomable document embedded in an application serving as the advertisement host, such that performing an action in the application (e.g., clicking on a “see other software related to this application” menu item) presents a document having a zoomable aspect with targeted content included within a second zoom state. As a third example, an advertisement may comprise a media item, such as a movie, embedded in a portion of a website serving as the advertisement host. One common embodiment of this example comprises a banner advertisement, in which an image is displayed at a fixed position and with a fixed resolution in a website. This example may be particularly amenable to the techniques provided herein; the small size of the banner advertisement may impose a significant practical limitation on the amount of displayed information that may be alleviated by implementing a zoomable aspect of the banner advertisement with targeted content featured in a second zoom state. Those of ordinary skill in the art may be able to devise many such combinations of advertisements and advertisement hosts of various types while implementing the techniques discussed herein.

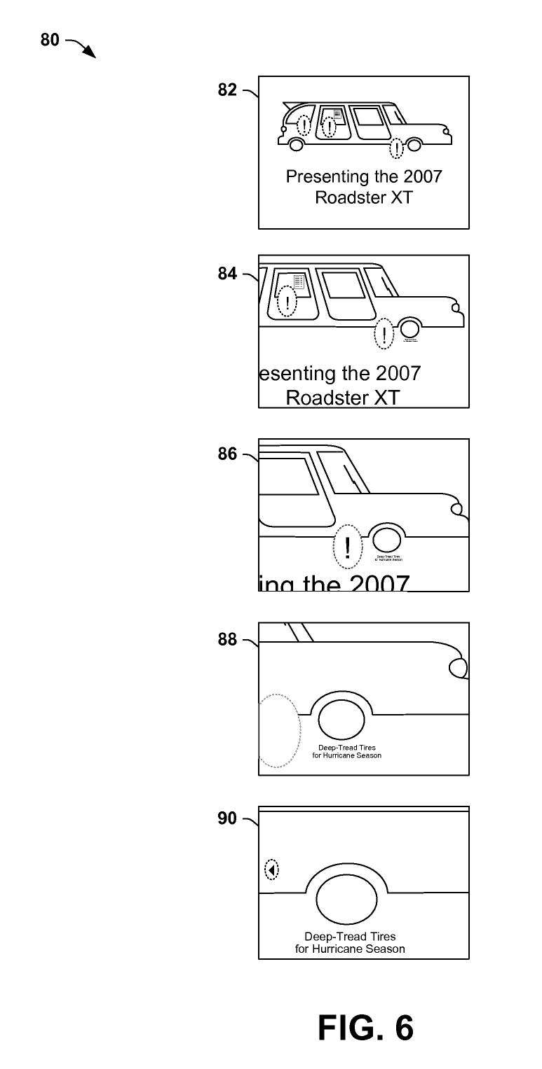

A third aspect that may vary among implementations relates to the nature of the zooming between zoom states in the advertisement. In one such embodiment, the advertisement is discretely zoomable, such that a zoom state transition presents the first zoom state and then presents the second zoom state with a fixed number (e.g., zero) of intervening zoom states. The transition may be instantaneous, or may involve some cross-fading, but the zooming in this embodiment might not clearly illustrate the relationship between the first zoom state and the second zoom state. An alternative embodiment that may present an improved user experience involves continuous zooming, where a transition from a first zoom state to a second zoom state is illustrated as a series of renderings of minutely altered zoom state, such that the directional and scaling nature of the zoom state transition is displayed. FIG. 6 presents an exemplary illustration 80 of a continuous zoom, wherein a transition from the first zoom state 82 (representing an overview image of the car advertised in FIG. 2 and FIG. 4) to the second zoom state 90 (representing a zoomed-in view of the front tire of the car) is displayed through a series of intermediate zoom state transitions 84, 86, 88, each zoom state transition varying from the previous and succeeding zoom state transitions by only a small amount. Through the use of continuous zooming, the advertisement may present to the user a clearer illustration of the relationship between the first zoom state and the second zoom state. Moreover, the second zoom state of such continuous zooming may include targeted content, such as illustrated in the second zoom state 90 of FIG. 6, as an embodiment of the techniques provided herein.

One implementation of a continuous zoom may involve scaling, such that, upon zooming in on a portion of the advertisement, the rendering computer system scales up the video data comprising the zoomed-in portion until it fills the display window. The zoomed-in image may comprise a rather “blocky” or pixilated display, but this may be supplemented with additional data from an external source to fill in the expanded resolution. For instance, if the advertisement comprises a bitmap, zooming in on a particular portion may comprise showing the pixels of the zoomed-in portion with greater per-pixel area (e.g., showing one source bitmap pixel as a 2×2 block of pixels, then as a 4×4 block of pixels, etc.) The final view may comprise only a few pixels shown with very large dimensions, but additional video data may be retrieved, e.g., from an advertising server, to provide more detailed information about the zoomed-in portion of the advertisement. This technique provides for a continuously zoomable advertisement that may be incorporated with the techniques presented herein; however, the user experience may be of low quality, with many video artifacts due to the per-pixel scaling technique, and a possible delay in patching the new information into the zoomed-in image may result in a short-term display of a few very heavily magnified pixels.

Another implementation of continuous zooming involves a continuous zoom where additional detail—even fine detail—is available for the entire advertisement, and may be rendered to provide a sharply displayed advertisement with abundant detail at any zoom state. Such rendering may be achieved in the context of three-dimensional graphics; for example, the advertisement may comprise three-dimensional objects (e.g., polygons) of various sizes and qualities, and may be rendered using a three-dimensional rendering engine. These techniques may be utilized to render a continuously zoomable advertisement having abundant detail at any zoom state, and including targeted content at a second zoom state, in accordance with the techniques provided herein. However, the rendering of a full three-dimensional scene is typically a much more computationally complex process than the rendering of an image, document, or movie, and often involves the use of specialized three-dimensional rendering hardware (e.g., 3D accelerator cards.) Such computational power may be undesirable or unachievable on portable devices with limited computational resources and battery life. Moreover, the amount of data involved in providing the details of many minute polygonal structures may be voluminous, and may involve transferring a significant amount of information over a computer network to the rendering device. For these and possibly other reasons, the use of three-dimensional graphics for providing a continuously zoomable advertisement may be undesirable.

Yet another alternative for the zooming aspect of these techniques involves a continuous zoom in an image using zoomably indexed data comprising a very wide range of detail, such that the image may be very quickly rendered at any zoom state with all available detail that could be provided based on all of the data comprising the image. Such techniques may be used to provide a continuously zoomable image with targeted content included at a second zoom state, such that the targeted content is viewable at the second zoom state but not at a first zoom state. These and many other techniques for implementing the zooming nature of the advertisement may be devised by those of ordinary skill in the art in accordance with the techniques provided herein.

A fourth aspect that may vary among implementations of the techniques presented herein relates to the generation and usage of user criteria through which the advertisement is targeted to the user. As one example, the techniques (such as the exemplary method 40 of FIG. 3) may include the detection of at least one user criterion relating to the user, which may be used in the selection of targeted content. The detecting may involve monitoring user behavior to choose user criteria for the targeting. For instance, the computer system may detect the location of the user by asking a direct question and accepting responsive user input, or by inference based on a zip code provided by the user. The computer system may then devise one or more user criteria representing the user, and the user criteria may store the user criteria in the memory of a system implementing these techniques, such as the user criteria memory 58 in the exemplary system 50 of FIG. 4.

Other examples involve the storage of user criteria on an external source, such as an external website, which cooperates in the generation of the advertisement including the targeted content. As one such example, a user may register an account with a website, such as an online retailer, and may provide demographic information during the signup process. The user may later view an advertisement for the website or hosted by the website on an advertisement rendering computer system, at which point the website may send one or more user criteria to the advertisement rendering computer system representing the user, which may be used to select targeted content to include in a second zoom state of the advertisement. Moreover, upon transitioning to the second zoom state, the advertisement rendering computer system may retrieve targeted content from an external source, such as an advertisement server, that relates to the user criteria, an may render the advertisement at the second zoom state with the targeted content. Alternatively, the advertisement rendering computer system may locally store a set of targeted content, such as illustrated in the advertisement memory 52 of FIG. 4, and may select targeted content based on the user criteria. As another such example, the user criteria memory may be limited to the website, such that instead of sending user criteria to the advertisement rendering computer system, the website may send targeted content selected by the website in relation to the at least one user criterion, and rendered by the advertisement rendering computer system within a second zoom state of the advertisement. Many variations in the generation and usage of user criteria for selecting targeted content to include within a second zoom state of the advertisement may be devised by those of ordinary skill in the art while implementing the techniques discussed herein.

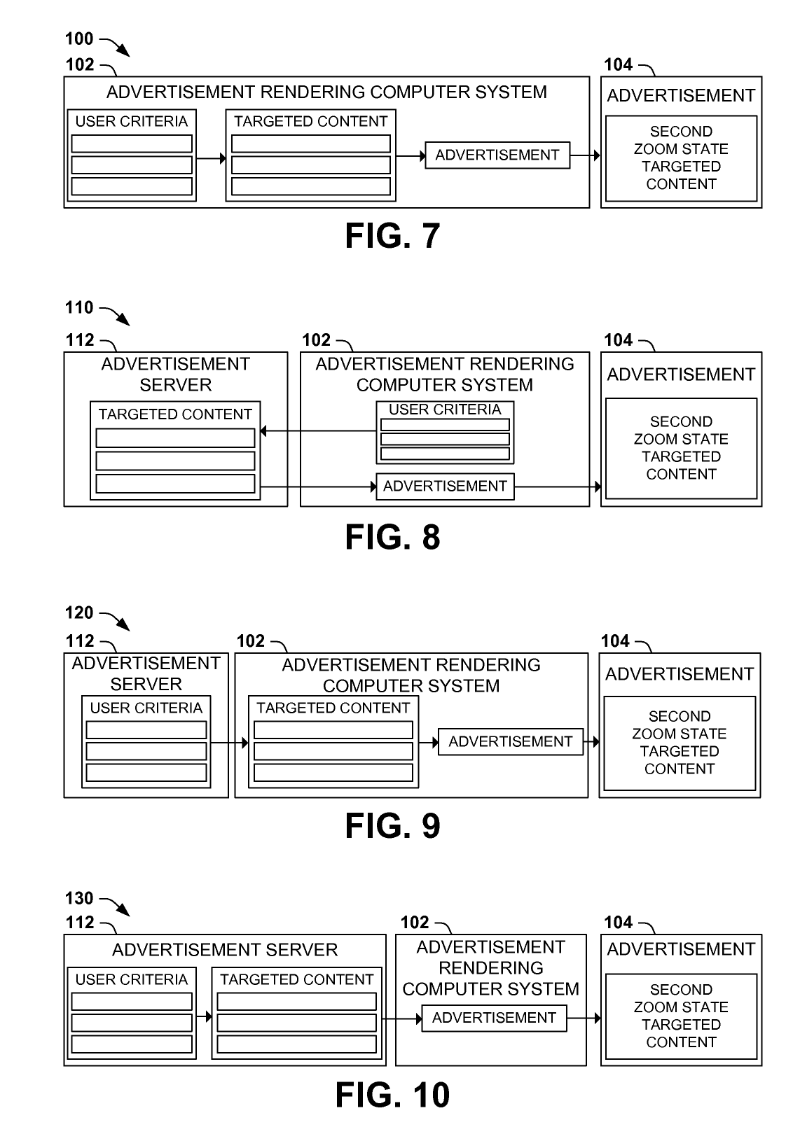

A fifth aspect that may vary among implementations of the techniques presented herein relates to the storage, selection, and retrieval of targeted content. Many variations of this aspect may be available, of which four are presented in FIGS. 7-10. FIG. 7 presents a first embodiment 100 wherein the user criteria and the targeted content are located on the advertisement rendering computer system 102; e.g., the advertisement rendering computer system 102 may store all of the advertised content, such as in the second zoom state descriptor set 54 of FIG. 4, and may combine the targeted content with an advertisement template 104 in order to render the advertisement 106 based on the user criteria representing the user viewing the advertisement 106. In this first embodiment 100, the advertisement rendering computer system 102 is capable of rendering the advertisement 106, including the targeted content at a second zoom level, without contacting an external server of any kind.

FIG. 8 illustrates a second embodiment 110, wherein the targeted content is stored on an advertisement server 112, while the advertisement rendering computer system 102 stores the user criteria. The advertisement rendering computer system 102 may then request targeted content from the advertising server 112 by sending the user criteria, and based on the user criteria, the advertising server 112 may select and send to the advertisement rendering computer system 102 an appropriate set of targeted content for combination with the advertisement template 104 to produce the advertisement 106. This embodiment may also vary based on the timing of the request; e.g., the advertisement rendering computer system 102 may request the targeted content when the advertisement 106 is first rendered, or prior to or during a transition of the advertisement 106 to a second zoom state featuring the targeted content. This second embodiment 110 may be advantageous where, e.g., the targeted content is maintained and updated by the advertising server 112 in order to maintain freshness in the advertisement set.

FIG. 9 presents a third embodiment 120, wherein the advertisement server 112 stores the user criteria and the advertisement rendering computer system 102 stores the targeted content. In this third embodiment 120, the advertisement rendering computer system 102 requests the advertisement server 112 to assist in the selection of targeted content for inclusion in the advertisement 106, either by specifying the targeted content to be selected from the targeted content memory of the advertisement rendering computer system 102 or by providing user criteria representing the user viewing the advertisement 106. The advertisement rendering computer system 102 then combines the targeted content with the advertisement template 104 to produce the advertisement 106. This third embodiment 120 may be advantageous where, e.g., the advertisement server 112 maintains the user profiles and accounts that contain the user criteria, such as an online retailer, or where the advertisement rendering computer system 102 may be used by a variety of users having different user criteria, such as an advertisement rendering kiosk computer in a public space.

FIG. 10 presents a fourth embodiment 130, wherein the advertisement server 112 stores both the user criteria and the targeted content, and provides suitable targeted content upon a generic request by the advertisement rendering computer system 102 for targeted content. The advertisement rendering computer system 102 may then accept the targeted content provided by the advertisement server 112 and combine it with the advertisement template 104 at a second zoom level to produce the advertisement 106. Again, the advertisement rendering computer system 102 may request the targeted content when the advertisement 106 is first rendered, or prior to or during a transition of the advertisement 106 to a second zoom state featuring the targeted content. This fourth embodiment 130 may be advantageous for, e.g., rendering an advertisement 106 on a thin-client computer system with little or no storage space. An extension of this embodiment involves the storage of the advertisement template 104 on the advertisement server 112, such that the advertisement server 112 sends the advertisement 106 and the targeted content to the advertisement rendering computer system 102 upon a generic request for an advertisement. Again, the targeted content may be included with the advertisement 106 as initially sent, or may be sent upon a transition of the advertisement 106 to a second zoom state displaying the targeted content. Many other variations in the storage, selection, and retrieval of the targeted content for inclusion in the advertisement may be devised by those of ordinary skill in the art while implementing the techniques discussed herein.

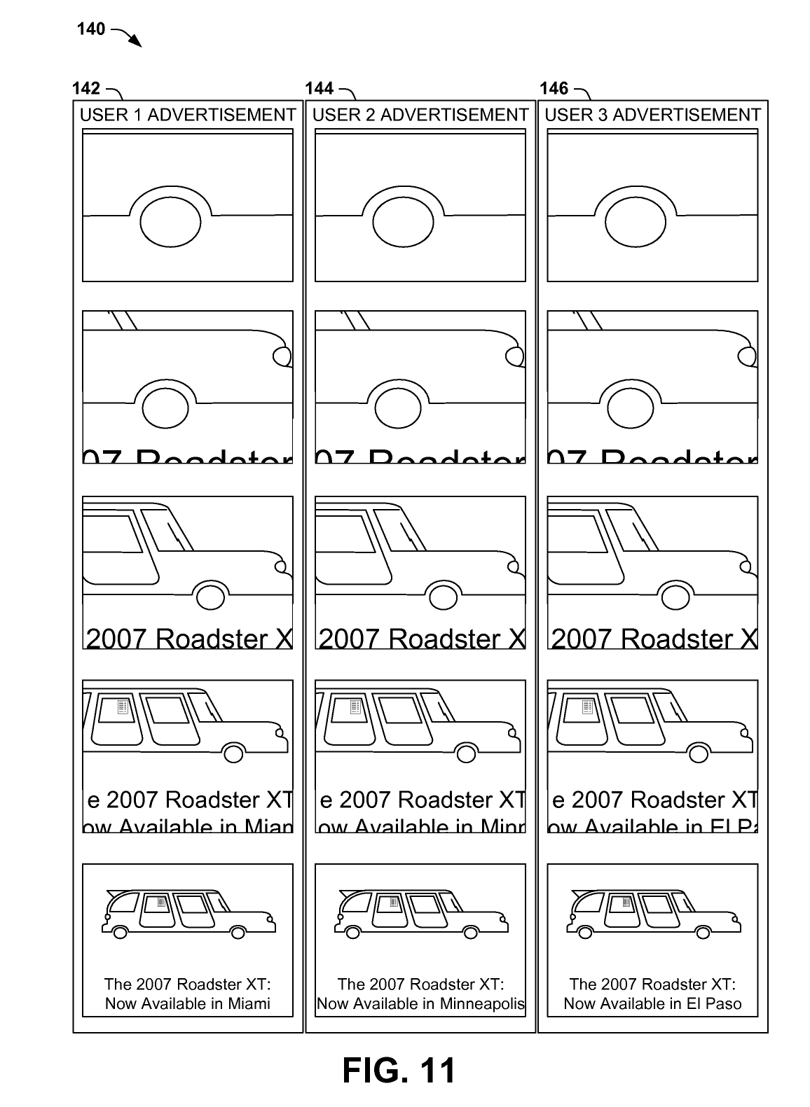

A sixth aspect that may vary among implementations of the techniques presented herein relates to the arrangement of the targeted content within the advertisement. The techniques disclosed herein involve displaying the advertisement at a first zoom state, and, upon transition to a second zoom state, displaying the advertisement at a second zoom state with targeted content. This arrangement may occur in many variations. As one example, such as illustrated in FIG. 6, the targeted content may be included in the advertisement at a fine level of detail, such that it may not be visible in a first zoom state comprising an advertisement overview panel (such as the first zoom state 82 of FIG. 6) but may come into view in a zoomed-in state (such as the second zoom state 90 of FIG. 6.) If the advertisement is continuously zoomable, or if the advertisement is discretely zoomable with at least a few transitional zoom states, then the targeted content may be arranged to come into view gradually as the transition progresses. An alternative arrangement is illustrated in the exemplary advertisement set 140 of FIG. 11, wherein the targeted content is included as a large feature, but where the first zoom state is zoomed in and the targeted content is arranged outside of the advertisement content viewable within the first zoom state. The exemplary advertisement set 140 of FIG. 11 includes a first user advertisement 142, a second user advertisement 146, and a third user advertisement 146. Each advertisement in this exemplary advertisement set 140 contains targeted content with respect to the exemplary user criteria set 10 of FIG. 1, but the targeted content is positioned and sized such that it is not viewable in the first zoom state of any advertisement, but becomes visible upon zooming out to a second zoom state. Again, and as illustrated in FIG. 11, an advertisement featuring continuous zooming aspect or a discrete zooming aspect with a few transitional zoom states may reveal the targeted content gradually as the transition progresses.

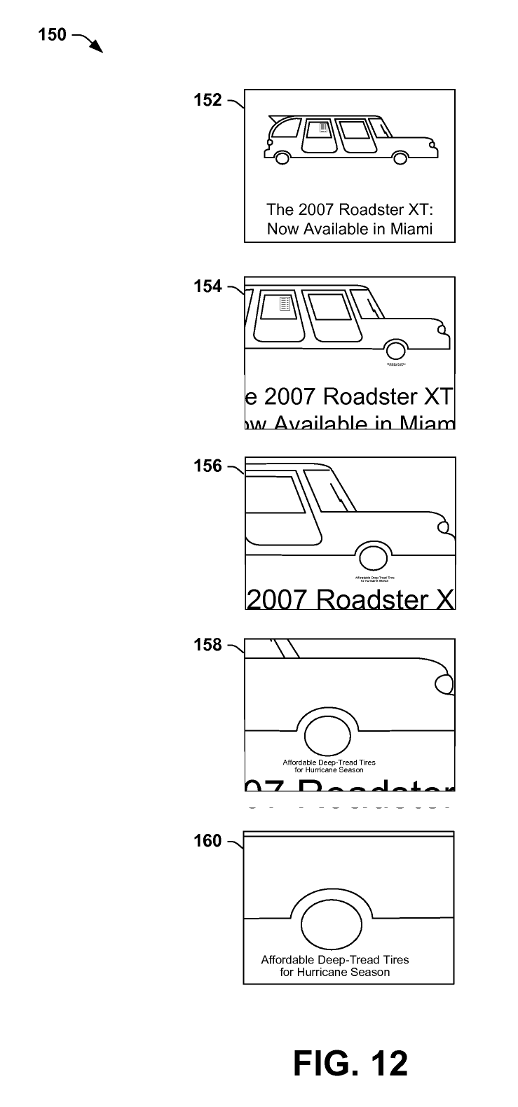

FIG. 12 presents another variation in the arrangement of targeted content within various zoom states of an exemplary advertisement 150 in accordance with the techniques presented herein. According to this variation, the first zoom state may include targeted content based on a first user criterion relating to the user, and the targeted content of the second zoom state may comprise targeted content based on both the first user criterion and a second user criterion relating to the user. In this manner, the advertisement may present an additional refinement of the targeted content, and/or targeted content more specific to the user, at the second zoom state than at the first zoom state. Accordingly, this example involves the targeting of the advertisement to the first user represented by the first user criteria 12 in the exemplary user criteria set 10 of FIG. 1. The targeting of this exemplary advertisement 150 is based on two such user criteria: the user's location (in this example, Miami, Fla.) and the user's age bracket, which may be indicative of an income status (in this example, an age of 22, indicative of a low-income status.) Accordingly, while selecting and arranging the targeted content within this advertisement, the first user criterion is used to insert some targeted content within the first zoom state 152—in this case, first zoom state 152 comprises an advertisement overview panel that mentions the availability of the car in the user's home city of Miami, Fla. The advertisement also includes a second zoom state 160 with targeted content based on the first user criterion and the second user criterion—in this case, the second zoom state 160 mentions both the availability of tires suitable for Miami's hurricane season, and also mentions an affordable price for the tires in view of the user's likely income bracket. An alternative advertisement generated for, e.g., an older visitor also located in Miami, Fla. might feature the same advertisement overview panel in first zoom state 152, but might include a different caption for the tire, e.g., the availability of a pricier but higher-performance all-weather tire with greater control during wet driving conditions. Many such variations in the selection and arrangement of targeted content among various zoom states may be devised by those of ordinary skill in the art while implementing the techniques discussed herein.

A seventh aspect that may vary among implementations of the techniques provided herein relates to the user interaction with the advertisement and the effects thereof. As one example, the zooming may be controlled in various manners and with various degrees of user control. In one embodiment, the zooming may be automated, such that the advertisement automatically transitions between zoom states in order to show various aspects of the advertisement, with targeted content incorporated at a second zoom state. Alternatively, upon detecting an advertisement interaction, the advertisement rendering computer system may render the advertisement transitioned to a new zoom state. In one such embodiment, the zooming may be assisted, such that the user is given a few options for transitioning to various zoom states, and the advertisement rendering computer system performs the transition to a selected zoom state. For instance, in the exemplary advertisement 20 of FIG. 2, the advertisement overview panel 28 includes indicators near a few areas having zoomable content. These indicators may be selectable, e.g., whereby clicking on an indicator with a pointing device (such as a mouse) causes the advertisement rendering computer system to transition to the zoom state associated therewith, whereas clicking anywhere else does not alter the zoom state. In still another embodiment, the zooming may be manually controlled, such that the user may zoom in anywhere within the advertisement, and may either transition among discrete magnification levels in an advertisement having a discrete zooming aspect, or may transition to an arbitrary magnification level in an advertisement having a continuous zooming aspect. Combinations of these embodiments may also be available (e.g., where the advertisement rendering computer system responds to user input, but also provides an automated tour of the areas with zoomable content in the absence of user input), and those of ordinary skill in the art may be able to devise many such techniques for zooming control while implementing the techniques discussed herein.

As another example of the user interaction aspect of the advertisements, the user may interact with the advertisement in such a manner as to solicit additional information, such as by clicking on the advertisement or a hyperlink provided therein. The advertisement rendering computer system may therefore be configured, upon detecting user interaction with the advertisement, to render a second advertisement relating to the advertisement (e.g., a more extensive advertisement for the same product, service, company, organization, etc. as advertised in the first advertisement.) For instance, in the context of webpages, banner advertisements may be configured to produce a pop-over or pop-under advertisement; this technique may be included in the zoomable advertisements having targeted content at a second zoom state in accordance with the techniques provided herein. Other examples are also available, e.g., where clicking on the advertisement causes additional information to be emailed to the user, or causes the application host (e.g., a webpage rendered in a web browser) to transition to a website having a second advertisement, or causes additional advertising content (e.g., a sales brochure) to be downloaded to the user's computer system. For instance, where the advertisement comprises a website embedded in another website serving as the advertisement host within a web browser, clicking on the advertisement may cause the website comprising the advertisement to fill the web browser, thereby replacing the website comprising the advertisement host. In this manner, the advertisement may represent a portal to another website, which the user may examine (through the zoomable aspect of the advertisement) before opting to visit the advertised website. Many variations may be devised in the effects of user interaction with the advertisement by those of ordinary skill in the art while implementing the techniques discussed herein.

In accordance with these variations of the user input aspect, an advertisement rendering system implemented in accordance with these techniques, such as the exemplary system 50 of FIG. 4, may include an input component configured to detect user input representing an advertisement interaction. Moreover, upon detecting user input, the targeted advertisement rendering component may be configured to respond to the user input, such as by rendering the advertisement transitioned to a particular zoom state, and/or by rendering a second advertisement relating to the advertisement.

An eighth aspect that may vary among implementations of the techniques discussed herein relates to the coupling of the advertisement rendering computer system with an advertisement tracking server. In these variations, the advertiser wishes to track the rendering of advertisements on various advertisement rendering computer systems, which may be advantageous, e.g., for facilitating the distribution of advertising revenue based on the volume of rendered advertisements through an advertisement host, such as where a website agrees to post advertisements on behalf of an advertiser in exchange for a per-rendering revenue stream. The notification of the advertisement tracking server may therefore promote sponsored advertisement hosting, and the techniques disclosed herein may be particularly advantageous where the hosted advertisement is restricted to a small, fixed-area region of the advertisement host, wherein the advertiser wishes to maximize the information presented in such a restricted space by utilizing the techniques discussed herein.

Accordingly, the advertisement rendering computer system may be configured to notify an advertisement tracking server upon the occurrence of various events relating to the rendering of an advertisement. The notification may represent, e.g., the rendering of the advertisement in the first zoom state; or the transition of the advertisement to the second zoom state including the rendering of the targeted content; or a user interaction with the advertisement. The advertisement rendering computer system may be configured to notify the advertisement tracking server of a variety of such events. For instance, systems configured to implement the techniques presented herein (such as the exemplary system 50 of FIG. 4) may include an advertisement tracking server notification component, which may be configured to notify the advertisement tracking server upon an occurrence of a rendering of the targeted content at the first zoom state, and/or a rendering of the targeted content at the second zoom state, and/or a user interaction with the advertisement. This variation may be useful because the different events may indicate different levels of interaction between the user and the advertisement (e.g., passively viewing the advertisement in a browser, utilizing the zoomable aspect of the advertisement to view more information, and interacting with the advertisement to view a second advertisement), which may be used to distribute advertising revenue based in part on the degree of interaction of each user with the advertisement. It may be appreciated that the advertisement tracking server may also serve as an advertisement server; i.e., a server may track the interaction of users with the advertisement based on requests from various advertisement rendering computer systems for various types of advertising content, such as an advertisement template, targeted content, and a second advertisement also served by the server. In this embodiment, the advertising content requested by various advertisement rendering computer systems also serve as the notification of various advertisement events, which the advertising server may record in order to compile an advertisement tracking record. Many variations in the tracking of advertising content may be devised by those of ordinary skill in the art while implementing the techniques discussed herein.

An additional variation of embodiments involving the notification of an advertisement tracking server of user interactions with the advertisement relates to the analysis of the user interactions. In addition to notifying the advertisement tracking server of the user interaction for advertisement revenue distribution, the user interactions may be informative as to user interest in various portions of the advertisement, interaction patterns with the advertisement among various groups of users, users' propensities to interact with various forms of advertisements and targeted content, etc. The user interactions may therefore be analyzed in many ways, and the information generated thereby may be used to inform an improvement of the advertisement (e.g., if users are rarely zooming in on an area of the advertisement having targeted content, some visual cues may be added to the advertisement to focus user attention on the zoomable area of the advertisement), and/or the generation of future ads that users may find more appealing or informative. Moreover, the advertisement rendering computer system may be configured to utilize this information in the presentation of the advertisement to users (e.g., by displaying for users a list of the most popular zoom states for viewing the advertisement, which may be generated automatically and included in future renderings of the advertisement.) Those of ordinary skill in the art may be able to devise many techniques for analyzing user interactions with the advertisement, and for utilizing the information in the presentation of renderings of the same and other advertisements, while implementing the techniques discussed herein.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it may be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of rendering an advertisement having at least two zoom states and targeting a user represented by at least one user criterion, the method comprising:
rendering the advertisement at a first zoom state; and
upon transitioning to a second zoom state, rendering the advertisement at the second zoom state with targeted content based on the at least one user criterion representing the user.

2. The method of claim 1, the advertisement comprising at least one of a website, a document, a media item, and an application.

3. The method of claim 1, the advertisement contained in an advertisement host comprising at least one of a website, a document, a media item, and an application.

4. The method of claim 3, the advertisement contained in an advertisement region within the advertisement host.

5. The method of claim 1, the advertisement comprising a continuously zoomable advertisement.

6. The method of claim 1, the targeted content arranged in the advertisement as viewable at the second zoom state and not viewable at the first zoom state.

7. The method of claim 1:
the first zoom state including targeted content based on a first user criterion relating to the user; and
the targeted content of the second zoom state comprising targeted content based on the first user criterion and a second user criterion relating to the user.

8. The method of claim 1, comprising: detecting at least one user criterion relating to the user.

9. The method of claim 1, the second zoom state rendering comprising:
upon transitioning to the second zoom state:
retrieving the targeted content from an advertisement server relating to the at least one user criterion, and
rendering the advertisement at the second zoom state with the targeted content.

10. The method of claim 1, comprising:
upon rendering the targeted content, notifying an advertisement tracking server of the rendering of the targeted content.

11. The method of claim 1, comprising:
upon detecting a user interaction with the advertisement, rendering at least one of:
the advertisement transitioned to a zoom state, and
a second advertisement relating to the advertisement.

12. The method of claim 11, comprising:
upon detecting an advertisement interaction, notifying an advertisement tracking server of the user interaction with the advertisement.

13. A computer-readable medium comprising processor-executable instructions configured to perform a method of rendering an advertisement targeted to a user and having at least two zoom states, the method comprising:
rendering the advertisement at a first zoom state; and
upon transitioning to a second zoom state, rendering the advertisement at the second zoom state with targeted content based on at least one user criterion relating to the user.

14. A system for rendering an advertisement having at least two zoom states and targeting a user represented by at least one user criterion, the system comprising:
an advertisement memory configured to store the advertisement and the targeted content;
a user criteria memory configured to store the at least one user criterion;
an advertisement zoom state indicator memory configured to store an advertisement zoom state indicator; and
a targeted advertisement rendering component configured to render the advertisement at the advertisement zoom state indicated by the advertisement zoom state memory, and upon transitioning to a second zoom state, to render within the second zoom state the targeted content targeting the at least one user criterion.

15. The system of claim 14, the advertisement comprising a continuously zoomable advertisement.

16. The system of claim 14, comprising:
an advertisement receiving component configured to receive the advertisement and the targeted content and to store the advertisement and the targeted content in the advertisement memory.

17. The system of claim 16, the advertisement receiving component configured to receive the advertisement and the targeted content prior to rendering the advertisement.

18. The system of claim 16, the advertisement receiving component configured to receive the advertisement prior to rendering the advertisement, and configured to receive the targeted content subsequent to rendering the advertisement at the first zoom state and prior to transitioning to the second zoom state.

19. The system of claim 14, comprising:
an input component configured to detect user input representing an advertisement interaction;
and the targeted advertisement rendering component configured, upon the input component detecting user input representing an advertisement interaction, to render at least one of:
the advertisement transitioned to a zoom state, and
a second advertisement relating to the advertisement.

20. The system of claim 14, comprising:
an advertisement tracking server notification component configured to notify the advertisement tracking server of at least one of:
a rendering of the targeted content at the first zoom state,
a rendering of the targeted content at the second zoom state, and
a user interaction with the advertisement.
